(19) United States
(12) Patent Application Publication
(10) Pub. No.: US 2025/0345794 A1
(43) Pub. Date: Nov. 13, 2025

(54) DEVICE AND METHOD FOR TRAPPING CELL PAIRS, AND METHOD FOR ANALYSING CELL PAIRS IN REAL TIME

(71) Applicants: CENTRE NATIONAL DE LA RECHERCHE SCIENTIFIQUE (CNRS), PARIS (FR); CENTRE HOSPITALIER UNIVERSITAIRE DE LILLE, LILLE (FR); INSTITUT NATIONAL DE LA SANTE ET DE LA RECHERCHE MEDICALE, PARIS (FR); UNIVERSITE DE LILLE, LILLE (FR); JUNIA, LILLE CEDEX (FR)

(72) Inventors: Dominique COLLARD, LAMBERSART (FR); Carine BRINSTER, MARQUETTE LEZ LILLE (FR); Loïc LEMONNIER, LILLE (FR); Bruno QUESNEL, LILLE (FR); Mehmet Cagatay TARHAN, LAMBERSART (FR); Yasmine TOUIL, LILLE (FR); Shaik FARUK AZAM, LILLE (FR)

(73) Assignees: CENTRE NATIONAL DE LA RECHERCHE SCIENTIFIQUE (CNRS), PARIS (FR); CENTRE HOSPITALIER UNIVERSITAIRE DE LILLE, LILLE (FR); INSTITUT NATIONAL DE LA SANTE ET DE LA RECHERCHE MEDICALE, PARIS (FR); UNIVERSITE DE LILLE, LILLE (FR); JUNIA, LILLE CEDEX (FR)

(21) Appl. No.: 18/860,955

(22) PCT Filed: Apr. 26, 2023
(86) PCT No.: PCT/EP2023/061039

§ 371 Date: Oct. 28, 2024

(30) Foreign Application Priority Data
Apr. 26, 2022 (EP) 22305625.0

(51) Int. Cl. B01L 3/00

(52) U.S. Cl. CPC B01L 3/502761; B01L 2200/0668; B01L 2300/0645; B01L 2300/0654

(57) ABSTRACT

The invention relates to a device for trapping at least one cell pair in a solution containing at least one first cell (C1) of a first type and at least one second cell (C2) of a second type, comprising: —a microfluidic channel (3) adapted for a unidirectional flow (F) of the solution; —a first trap (1) comprising a pair of first fingers (10a, 10b) arranged in the microfluidic channel (3), at least one of said first fingers (10a, 10b) being coupled to a respective first actuator (11a, 11b), said first actuator being configured to adjust the first trap (1) along a direction transversal to the flow (F) between an open position allowing passage of the first cell between the first fingers (10a, 10b) and a closed position adapted to a size of the first cell to allow trapping the first cell between the first fingers (10a, 10b); 15—a second trap (2) comprising a pair of second fingers (20a, 20b) arranged in the microfluidic channel (3), at least one of said second fingers (20a, 20b) being coupled to a respective second actuator (21a, 21b), said second actuator being configured to adjust the second trap (2) along a direction transversal to the flow (F) between an open position allowing passage of the second cell between the second fingers (20a, 20b) and a closed position adapted to a size of the second cell to allow trapping the second cell between the second fingers (20a, 20b); wherein the first trap (1) is arranged relative to the second trap (2) so as to form, when the first and second traps are in the closed position, a cell pair comprising the trapped first and second cells such that the second cell is in physical or chemical interaction with the first cell.

### TECHNICAL BACKGROUND

Cell-cell interactions play a crucial role in various biological systems, and notably in immunity, where cell pairing initiates and mediates many critical developmental (selection, proliferation, differentiation) and functional (cytolysis, cytokine and antibody production) immune responses (R. D. Schreiber, L. J. Old, and M. J. Smyth, Science, vol. 331, no. 6024, pp. 1565-70, 2011). In this context, a better understanding of interaction dynamics between immune cells and their cellular partners is fundamental.

These interactions are usually studied by activating cells in bulk co-cultures, mixing cell populations and initiating contacts with a brief centrifugal co-sedimentation, and then piecing together measurements from independent assays performed at different time points. While such bulk co-cultures have revealed key information about these interactions, results are unfortunately averaged between many different cell types and combinations of interactions (B. Dura and J. Voldman, Current opinion in immunology, vol. 35, pp. 23-9, 2015). These technical approaches are indeed masking intrinsic cellular heterogeneity regarding the interaction potential, variation in the antigen presenting cells, and contact durations, all parameters which are known to modulate immune responses (B. Dura and J.

Voldman, Current opinion in immunology, vol. 35, pp. 23-9, 2015). In onco-immunology, there is increasing evidence that population-wide measures do not reflect the tumour fate by masking single-cell behaviour.

Furthermore, while immunotherapy with immune checkpoint inhibitors (ICIs) has completely changed the therapeutic landscape in cancer treatment (A. Ribas and J. D. Wolchok, Science, vol. 359, no. 6382, pp. 1350-1355, 2018), not all types of cancers respond equally well to ICIs, and even in responsive cancers, only a subset of patients experiences durable responses and favourable long-term outcomes. The heterogeneity intra- and inter-patients in regard to immune responses could explain variability in ICIs efficiency. Therefore, it is crucial to establish methods to analyse single-cell interaction(s) and behaviour in real-time, in a non-artificial cell environment, in order to identify reliable predictive biomarkers to distinguish ICI responders from non-responders and to identify candidates for rational combination therapies, these personalized approaches being now recognized as fundamental in the onco-immunology field.

Several microscale tools to study single-cell interaction exist A common approach is to isolate discrete numbers of cells in microwells, microchambers, or droplets, and monitor their interactions with multiple measurements (B. Dura and J. Voldman, Current opinion in immunology, vol. 35, pp. 23-9, 2015). Although these approaches have made it feasible to resolve the relationships between different immune responses (B. Dura and J. Voldman, Current opinion in immunology, vol. 35, pp. 23-9, 2015), they have some limitations as they do not enable to study early signalling dynamics (calcium entry, immune synapse formation . . . ) nor their correlation to subsequent functional cellular events.

To analyse or modify the immunological status of patients, it is also important to be able to isolate living individual cells (e.g., individual T lymphocytes or cancer cells) after their interaction. As a matter of fact, post-synapse cell isolation is crucial to analyse single cell-omics, or to expand them in vitro, to analyse them or to organize an adoptive transfer for in vivo studies.

Microfluidics are ideally suited to study single cell behaviour and isolate post-synapse living cells individually. Some microfluidic devices have been even able to study cell interactions: A device for pairing cells of different sizes has also been described in Fairuk A. Shaik et al, Pairing cells with different dimensions in a microfluidic device using a unidirectional flow, the 24th International Conference on Miniaturized Systems for Chemistry and Life Sciences; 2020 Oct. 4-9. Said device comprises a microfluidic channel in which an array of trapping sites had been arranged. Each trapping site was made of a three-layer structure comprising, from the bottom to the top of the microfluidic channel, a first layer allowing a solution containing the cells to flow along the microchannel, a second layer forming a trap adapted to the expected size of the smaller cell and a third layer forming a trap adapted to the expected size of the bigger cell.

Another device for pairing cells has been described in Shaik Faruk Azam et al, Pairing cells of different sizes in a microfluidic device for immunological synapse monitoring. Lab Chip. 2022; 22(5):908-20. Said device comprises two parallel microfluidic channels separated by a wall presenting synaptic openings, and micropillars arranged on both sides of the synaptic openings to form respective trapping sites adapted to retain a cell in a solution flowing in a respective channel.

However, in these devices, the trapping sites have a pre-determined and fixed size that cannot work to efficiently pair cells having a size which is different from the expected size. Besides, once cells have been trapped in the trapping sites, it is generally necessary to reverse the flow within the microfluidic channel to release the cells from the trapping sites, which is not convenient.

Consequently, despite the existence of very complex systems, there is currently no microfluidic device that is able i) to analyse the naturally occurring physical interaction and behaviour of primary cells in a non-artificial environment, ii) to immobilize a high number of cell pairs without affecting their viability, iii) to separate the cells after their interaction so as to potentially expand them in vitro, wherein the cells are preferably of different size and non-frequent (e.g., stem cells, dormant cells, etc.).

More precisely, there exists currently no microfluidic cell pairing devices enabling to study cell-cell interactions between living primary human lymphocytes and their partners (e.g, primary cancer cells), with the possibility to (i) screen therapeutic or candidate molecules, and (ii) to retrieve individual T or cancer cells post-synapse formation. Even more precisely, no protocol exists to decipher the molecular events occurring at the immunological synapse scale between primary cancer cells from patients and the crucial T cells, either in a clinical context or in a tumour dormancy context.

### SUMMARY OF THE DISCLOSURE

The invention provides a device for trapping at least one cell pair in a solution containing at least one first cell of a first type and at least one second cell of a second type, comprising:
a microfluidic channel adapted for a unidirectional flow of the solution;
a first trap comprising a pair of first fingers arranged in the microfluidic channel, at least one of said first fingers being coupled to a respective first actuator, said first actuator being configured to adjust the first trap along a direction transversal to the flow between an open position allowing passage of the first cell between the first fingers and a closed position adapted to a size of the first cell to allow trapping the first cell between the first fingers;
a second trap comprising a pair of second fingers arranged in the microfluidic channel, at least one of said second fingers being coupled to a respective second actuator, said second actuator being configured to adjust the second trap along a direction transversal to the flow between an open position allowing passage of the second cell between the second fingers and a closed position adapted to a size of the second cell to allow trapping the second cell between the second fingers;
wherein the first trap is arranged relative to the second trap so as to form, when the first and second traps are in the closed position, a cell pair comprising the trapped first and second cells such that the second cell is in physical or chemical interaction with the first cell.

In some embodiments, in closed position the second trap is larger than the first trap so as to allow trapping a second cell larger than the first cell in the second trap.

In some embodiments, each first finger is coupled to a respective first actuator and each second finger is coupled to a respective second actuator.

Said first and second actuators may be configured to move the first trap relative to the second trap to detach the first cell from the second cell and to open the first and second traps to release the first and second trapped cells within the flow.

In some embodiments, each first or second finger is coupled to the respective first or second actuator by a respective first or second rod substantially perpendicular to the flow.

Each of said first and second rods may support at least two first or second fingers, respectively, so as to form at least two first and second traps adjustable simultaneously by the first and second actuators, respectively.

In some embodiments, the device may further comprise two pairs of foldable beams extending along the flow and connected to one of the first and second rods, each end of said foldable beams being fixed relative to the microfluidic channel, wherein each foldable beam is deformable by a respective first or second actuator to move the respective first or second rod in a direction transversal to the flow to adjust the first or second trap(s).

In some embodiments, the device further comprises a control unit configured to receive a size of the first and second cells and to control the first and second actuators to adjust a distance between the first fingers and between the second fingers in the closed position of the first and second traps based on said received size of the first cell and of the second cell, respectively.

The device may further comprise a measuring unit adapted to measure in real time a size of the first and second cells, the control unit being configured to receive in real time said measured size of the first and second cells.

In some embodiments, the device further comprises at least one mechanical or electrical sensor adapted to detect that a cell has been trapped in a respective first, second and, if appropriate, third trap.

In some embodiments, at least one of the first actuators is configured to adjust a size of the first trap in the closed position after a first cell has been trapped to allow trapping also one third cell in the first trap to form a cell triplet with the second cell trapped in the second trap such that the first, second and third cells are in physical or chemical interaction.

In some embodiments, the device further comprises a third trap comprising a pair of third fingers arranged in the microfluidic channel, at least one of said third fingers being coupled to a respective third actuator, said third actuator being configured to adjust the third trap along a direction transversal to the flow between an open position allowing passage of a third cell between the third fingers and a closed position adapted to a size of the third cell to allow trapping the third cell between the third fingers;
wherein the third trap is arranged relative to the first and second traps so as to form, when the first, second and third traps are in the closed position, a cell triplet comprising the trapped first, second and third cells such that the first, second and third cells are in physical or chemical interaction.

In some embodiments, the device further comprises an array of electrically isolated electrodes arranged on a bottom of the microfluidic channel such that an overlapping area of two electrodes is located under each trap, at least one surface of each electrode being exposed in a recess in said overlapping area, each electrode being connected to an electrical source so as to selectively apply a potential difference to the solution at each overlapping area.

Another object of the invention is a method for trapping at least one cell pair in a solution containing at least one first cell of a first type and at least one second cell of a second type, comprising:
flowing the solution in the microfluidic channel of the device as described above;
activating at least one first actuator to dose the first trap, the size of the first trap in the closed position being adapted to the size of the first cell;
trapping one first cell in the first trap;
activating at least one second actuator to dose the second trap, the size of the second trap in the closed position being adapted to the size of the second cell;
trapping the second cell in the second trap, said second cell forming a cell pair with the first cell, the second cell being in physical or chemical interaction with the first cell.

Another object of the invention is a method for trapping a cell triplet in a solution containing at least one first cell of a first type, at least one second cell of a second type different from the first type, and at least one third cell of a third type, comprising:
flowing the solution in the microfluidic channel of the device as described above;
activating at least one first actuator to close the first trap, the size of the first trap in the closed position being adapted to the size of the first cell;
trapping one first cell in the first trap;
activating at least one first actuator to adjust a size of the first trap in the closed position to be adapted to the size of both the first and the third cells;
trapping one third cell in the first trap;
activating at least one second actuator to close the second trap, the size of the second trap in the closed position being adapted to the size of the second cell;
trapping one second cell in the second trap, said second cell forming a triplet with the first and third cells, the first, second and third cells being in physical or chemical interaction.

In some embodiments, the first and second traps are in an initial open position in which the first trap is distant from the second trap in a direction transversal to the flow and, after the first and second cells have been trapped in the first and second traps, the first and/or the second actuators are activated to bring the first and second traps closer to each other to create the cell pair or cell triplet.

The method may further comprise releasing at least one of the first, second and, if appropriate, third cells, by activating the first and/or second actuators to move at least one of the first and second traps away from the other trap in a direction transversal to the flow and to open at least one of the first and second traps to release the cell(s) trapped in the respective trap.

Alternatively, the method may comprise releasing at least one of the first, second and, if appropriate, third cel from a selected trap by applying, to the electrodes overlapping under said trap, an electrical potential difference greater than an electrical potential difference triggering electrolysis, dielectrophoresis or electroosmosis of the solution in the respective recess, so as to generate a bubble adapted to push the first, second and/or third cell out of the trap.

Another object of the invention is a method for analyzing real-time interactions of at least one pair or triplet of cells, comprising:
trapping at least one cell pair of cell triplet with a method as described above;
acquiring data relating to the interaction of said cell pair or cell triplet with at least one of an optical sensor, an electrical sensor, a mechanical sensor and a chemical sensor.

Said method may further comprise exposing the at least one trapped cell pair or cell triplet to one or more solution(s) having a determined pH and/or a determined viscosity, said pH or viscosity being chosen to simulate cell interaction in a determined situation.

The invention further provides a system for analyzing real-time interactions of at least one pair or triplet of cells, comprising:
a device as described above, and
at least one of an optical sensor, an electrical sensor, a mechanical sensor and a chemical sensor configured to acquire data relating to the interaction of a pair or triplet of cells trapped by the device.

### BRIEF DESCRIPTION OF THE FIGURES

Additional features and advantages of the invention will appear from the following detailed description, based on the appended drawings, in which:

FIGS. 1A-1E illustrate a sequence of operation of the device according to an embodiment of the invention to allow trapping a cell pair;

FIGS. 2A-2F illustrate a sequence of operation of the device according to an embodiment of the invention to allow trapping a cell triplet;

FIGS. 3A-3C illustrate a sequence of operation of the device according to an embodiment of the invention to allow releasing cells of the first type and FIGS. 3D-3E illustrate a sequence of operation of said device to allow releasing cells of the second type;

FIGS. 4A-4E illustrate a sequence of the device according to an embodiment of the invention to allow trapping simultaneously a plurality of cell pairs;

FIG. 5 illustrates a perspective view of a device according to an embodiment of the invention;

FIG. 6 illustrates the traps of the device of FIG. 5 in an open position;

FIG. 7 illustrates the traps of the device of FIG. 6 in a closed position.

FIG. 8 illustrates the cell capture trap and cell pairing. a) SEM images show a close-up view of a trap with two capture sites. These figures correspond to the capture site of the device of the innovation. b) A view of paired Immune cells (white, Fura2-AM calcium probe) and Leukemia cells (dark, DiI staining) in brightfield (top left) and fluorescent (top right). Cells are paired regardless of their sizes (bottom).

FIG. 9 illustrates how to monitor cell activities in the cell pair. Ca²⁺ imaging experiments showing immune cells (Natural killer cells, NK92 cells) activity (Ca²⁺ mobilization) following Immune Synapse (IS) formation with Leukemia cells (K562 leukemic cells);

FIG. 10 schematically illustrates an embodiment of the device comprising an array of electrodes configured for generating a bubble in order to selectively retrieve a single cell, a trapped cell pair or cell triplet from a trap;

FIGS. 11A-11C schematically illustrate embodiments of the array of electrodes.

### DETAILED DESCRIPTION OF EMBODIMENTS

In this context, the present inventors herein propose a particular microfluidic cell pairing device that has been set-up to solve these needs, i.e., to study cell-cell interactions between primary cells and their interaction partners (e.g., primary cancer cells and lymphocytes).

Their device comprises a microfluidic channel adapted for a unidirectional flow of a solution comprising in order to dynamically accommodate its geometry to the size of the target cells of a patient, and therefore trap cells of different sizes, such as lymphocyte-cancer cell pairs. This cell pairing tunable device overcomes the limitations of current cell pairing systems to manage different sizes and cell types differences.

By making the trapping structure mobile and actuating it, the inventors could adjust in real time the size of the trapping zones for different cell types to optimize the cell pairing. No stress is therefore applied on the different cell types. Moreover, after the pairing, the actuated traps can mechanically separate the cells and release them type by type. Finally, the cells are preferably paired in multiple sites in parallel (in average about 100), so as to increase the statistical relevance of the assay.

As explained below, the present device enables to analyse the molecular events occurring at the synapse between two cells as well as those occurring within the two cells during their interaction, for example with real-time imaging or confocal microscopy. It furthermore allows the stimulation of the trapped cells with candidate molecules or the identification of particular biomarker that might predict the outcome of the disease or the susceptibility to a treatment.

Finally, and importantly, the device of the invention enables to retrieve the individual cells after the formation of the synapse, so as to expand them in vitro, in the aim of analysing them further, or transferring them back into the patient, possibly after their treatment.

The device of the invention comprises a microfluidic channel adapted for a unidirectional flow of a solution comprising cells. The solution can comprise a mixture of cells of at least two different types; alternatively, two solutions can flow successively in the microfluidic channel, one with cells of a first type and one with cells of a second type.

The cells of the first and second types can be identical or different. In some embodiments, the cells of the first type have a different size than the cells of the second type; in the examples developed below, the cells of the first type have a smaller size than the cells of the second type.

At least two adjustable traps are arranged in the microfluidic channel.

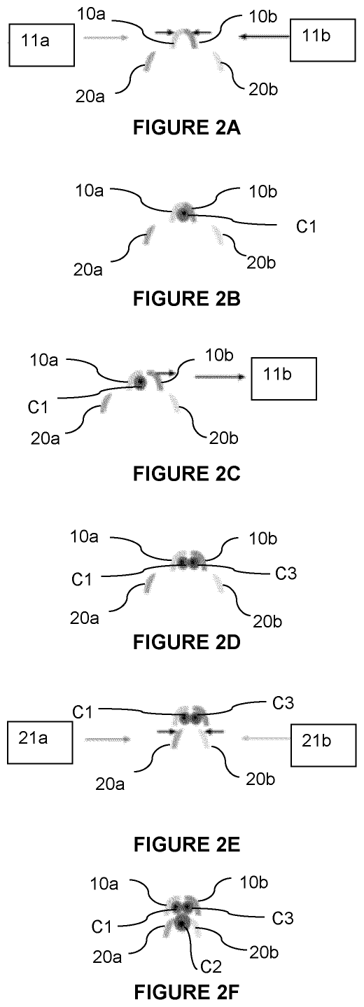

A first trap is configured to trap a cell of the first type and a second trap is configured to trap a cell of the second type. In general, each trap is configured to trap one cell of the respective type. However, in some embodiments (see FIGS. 2A-2F that will be described in detail below), one trap may be configured to trap two cells, in order to form a cell triplet.

The traps may have different heights (the height being the dimension according to a direction perpendicular to the bottom of the microfluidic channel). For example, the bigger the cell to be trap, the greater the height of the trap.

The traps may not be arranged at the same position in the microfluidic channel. In particular, especially if the first trap is intended to trap a smaller cell than the second trap, the first trap may be located upstream of the second trap along the direction of flow of the solution, the distance along said direction being chosen to allow interaction between cells trapped in the first and second traps.

Each trap comprises a pair of fingers arranged in the microfluidic channel, at least one of said fingers being coupled to a respective actuator. Said actuator is adapted to move one of both fingers in order to adjust the first trap along a direction transversal to the flow between an open position allowing passage of the first cell between the fingers and a closed position adapted to a size of the cell to be trapped to allow trapping said cell between the fingers. Having only one finger coupled to an actuator allows simplifying the design of the device. However, having both fingers coupled to a respective actuator allows increasing the versatility of the device, for example, by allowing displacing a whole trap in the transversal direction. In particular, it may be advantageous to have the first and second trap initially offset from each other in the transversal direction, in order to facilitate trapping of the first and second cells in the respective trap, and then to move the first and second traps relative to each other in the transversal direction to align them along the direction of the flow and form the cell pair.

By “trapping” is meant in the present text that the cell is retained in the trap, preferably with minimal constraint applied by the fingers onto the cell, so that the cell remains in a substantially free state. To that end, the trap does not require to be fully closed, i.e. with an intimate contact between the fingers. Even in the closed position, the fingers may be separated by a small gap, provided that said gap is smaller than the size of the cell, so that the cell cannot pass through the gap.

The first and second traps are arranged relative to each other so as to form, when the first and second traps are in the closed position, a cell pair comprising the trapped first and second cells, in which interactions between the first and second cells can occur.

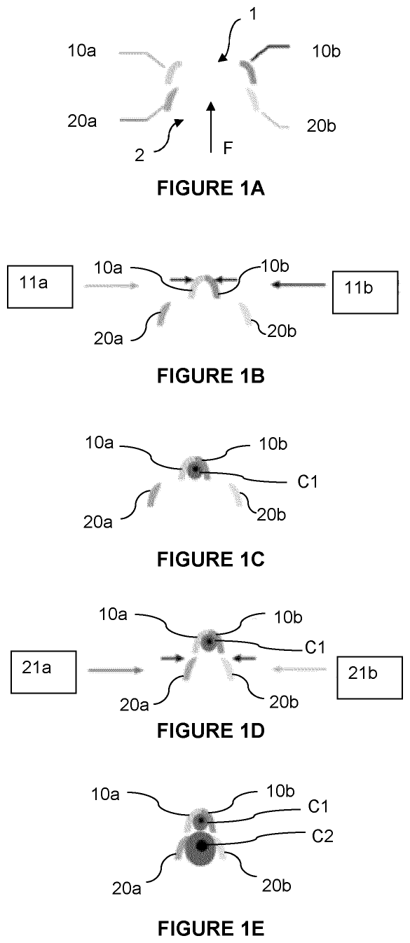

FIGS. 1A to 1E schematically illustrate the operation of the first and second traps, see from the top of the microfluidic channel.

FIG. 1A represents the fingers 10a, 10b of the first trap 1 and the fingers 20a, 20b of the second trap 2 in an open position. The direction of the flow is represented by arrow F.

FIG. 1B represents the fingers 10a, 10b of the first trap 1 in the closed position while the fingers 20a, 20b of the second trap 2 are still in the open position. To reach said closed position, the fingers 10a, 10b have been moved toward each other in a direction transversal to the flow F by respective actuators (not shown).

FIG. 1C represents the same configuration as in FIG. 1B, with a first cell C1 trapped in the first trap 1.

FIG. 1D represents the first trap 1 still in the closed position with the trapped first cell C1 and the second trap 2 in the closed position. To reach said closed position, the fingers 20a, 20b have been moved toward each other in a direction transversal to the flow F by respective actuators (not shown).

FIG. 1E represents the same configuration as in FIG. 1D, with the first cell C1 trapped in the first trap 1 and a second cell C2 trapped in the second trap 2. The first and second traps 1, 2 are close enough to each other to form a cell pair with cells C1 and C2, i.e. interactions between cells C1 and C2 are allowed, even if the cells C1, C2 do not physically contact each other. The skilled person can design the size and arrangement of the traps in accordance with the size of the cells to be trapped and the type of interaction to be observed.

Of course, the invention is not limited to the trapping of a pair of cells, but can be applied to the trapping of a triplet of cells, or even of a set of more cells. In such case, the number of traps or the configuration of the traps can be adapted to allowing building the desired cells set.

The trapping of a cell triplet can be done by various ways.

In some embodiments, a third trap (not shown) is added, with the same design as the first and second traps, i.e. two fingers and at least one actuator. Said third trap can be aligned with the first and second trap along the direction of the flow. The size of the third trap is adjusted to the size of the cell to be trapped.

In other embodiments, as shown in FIGS. 2A-2F, one of the first and second traps (in the present case, the first trap) is designed to trap two cells. In this way, it is not necessary to add a third trap distinct from the first and second traps to trap the third cell, which would increase the complexity of the device.

FIG. 2A represents the fingers 10a, 10b of the first trap 1 in the closed position and the fingers 20a, 20b of the second trap 2 in the open position. The direction of the flow is represented by arrow F.

FIG. 2B represents the same configuration of the traps 1 and 2 as in FIG. 2A, with a first cell C1 trapped in the first trap 1.

FIG. 2C represents the second trap 2 still in the open position. The first trap 1 has been partially re-opened by moving the finger 10b away from the finger 10a while still retaining the first cell C1. The width of opening of the first trap 1 is adapted to allow trapping an additional cell C3, as shown in FIG. 2D. The cell C3 may be of the same type as the cell C1, or of a different type. Advantageously, the cells C1 and C3 have substantially the same size.

FIG. 2E represents the first trap 1 in the same configuration as in FIG. 2D, with the cells C1 and C3 trapped in the trap 1, while the second trap 2 is in the closed position.

FIG. 2F represents the first and second traps in the same configuration as in FIG. 2E, with a cell C2 trapped in the second trap 2. Thus, a cell triplet has been formed with cells C1, C2 and C3.

The trapping device is particularly advantageous in that it allows not only to form a cell pair or a cell triplet, but also to easily release the trapped cells once the interactions between the cells have been observed, without changing the flow in the microfluidic channel. To the contrary, in the case of fixed traps, releasing trapped cells is quite complex and generally requires that a solution be flown in the reverse direction of the flow F to force the cells to leave the traps.

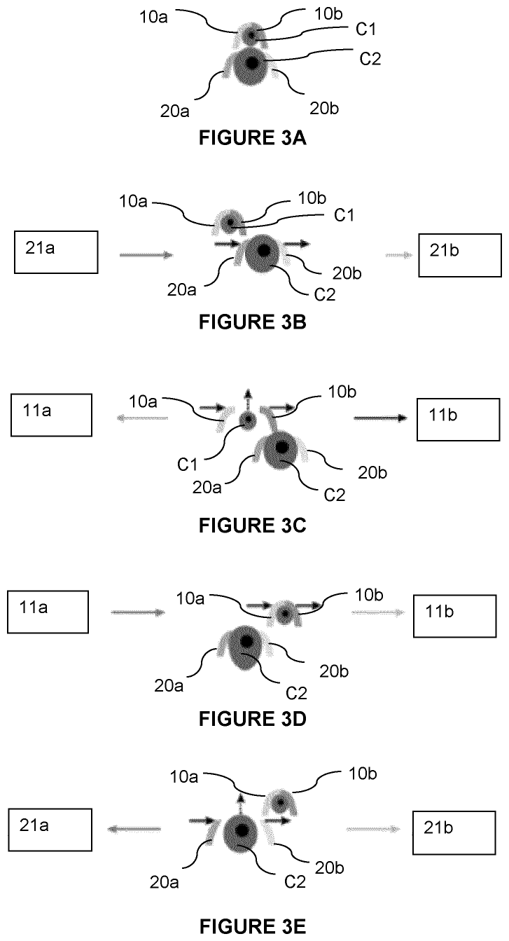

FIG. 3A represents the traps 1 and 2 in closed position, with a pair of first and second cells C1, C2 trapped in a respective trap.

As shown in FIG. 3B, the second trap 2 is moved away from the first trap 1 in a direction transversal to the flow F, the second trap 2 being still in the closed position. Thus, the traps 1 and 2 are both closed but offset from each other in the transversal direction. This displacement allows detaching the first cell from the second cell.

As shown in FIG. 3C, the first trap 1 is opened by moving at least one of the fingers 10a, 10b by a respective actuator. As a consequence, the cell C1 is released and leaves the trap 1 in the direction of the flow F through the opening between the fingers 10a, 10b.

FIG. 3D represents the traps 1 and 2 in closed position, with a pair of first and second cells C1, C2 trapped in a respective trap. The second trap 2 is moved away from the first trap 1 in a direction transversal to the flow F, the second trap 2 being still in the closed position. Thus, the traps 1 and 2 are both closed but offset from each other in the transversal direction. This displacement allows detaching the first cell from the second cell.

As shown in FIG. 3E, the second trap 2 is opened by moving at least one of the fingers 20a, 20b by a respective actuator. As a consequence, the cell C2 is released and leaves the trap 2 in the direction of the flow F through the opening between the fingers 20a, 20b, without interfering with the first trap 1.

Of course, the sequences illustrated in FIGS. 3A-3C and 3D-3E can also be implemented concurrently, i.e., by moving the closed traps away from each other in a direction transversal to the flow and opening simultaneously the first and second traps.

As shown in FIG. 3E, the second trap 2 is opened by moving at least one of the fingers 20a, 20b by a respective actuator. As a consequence, the cell C2 is released and leaves the trap 2 in the direction of the flow F through the opening between the fingers 20a, 20b. Since the first trap 1 is offset from the second trap 2 in the transversal direction, the first trap does not hinder the cell C2 from flowing with the solution.

Thus, the device is again ready for the trapping of a new pair of cells.

Although FIGS. 1A to 3E presented the operation of the device to trap one cell pair or cell triplet, the device can of course be designed to trap a plurality of cell pairs or triplets simultaneously.

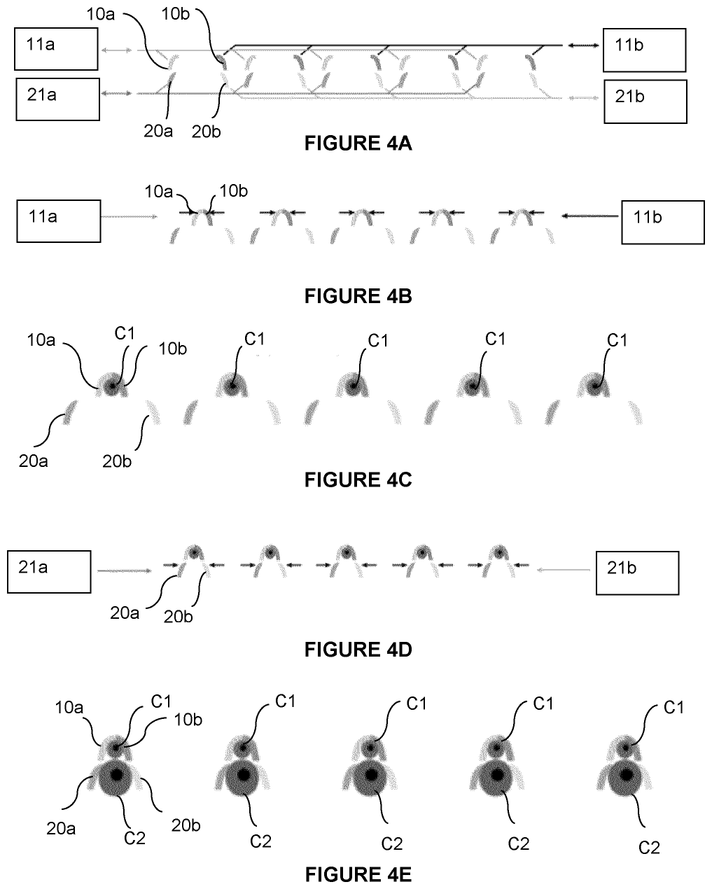

For example, as shown in FIG. 4A, the device can comprise a plurality of first traps 1 (e.g. five first traps) and a plurality of second traps 2 (e.g. five second traps). As described previously, each first trap 1 comprises a finger 10a and a finger 10B movable relative to each other in a direction transversal to the flow F. Preferably, to simplify the design and operation of the device, all the fingers 10a are coupled to a same first actuator (not shown) and all the fingers 10b are coupled to a same second actuator (not shown). Similarly, each second trap 2 comprises a finger 20a and a finger 20B movable relative to each other in a direction transversal to the flow F. Preferably, to simplify the design and operation of the device, all the fingers 20a are coupled to a same first actuator (not shown) and all the fingers 20b are coupled to a same second actuator (not shown).

In FIG. 4A, all the traps are in the open position. Preferably, each first trap is aligned with a respective second trap in the direction of the flow F.

As shown in FIG. 4B, the first traps 1 are simultaneously closed. Preferably, both fingers of each first trap 1 are moved by a same distance toward each other to maintain the first traps aligned with the second traps.

As shown in FIG. 4C, cells C1 are trapped in each first trap 1.

As shown in FIG. 4D, the second traps 2 are simultaneously closed. Preferably, both fingers of the second traps 2 are moved by a same distance toward each other to maintain the second traps aligned with the first traps.

As shown in FIG. 4E, cells C2 are trapped in each first trap 2, thereby forming a cell pair with the cell C1 trapped in the respective first trap 1.

Once the cell pairs have been observed, the first cells can be released simultaneously and the second cells can be released simultaneously, by operating the device as described with reference to FIGS. 3A-3E. Alternatively, the whole pairs of cells can be released simultaneously by opening all the traps.

The actuators are controlled by a control unit.

The control unit is configured to receive a size of the first and second cells and to control the first and second actuators to adjust the gap between the fingers of the first trap and between the fingers of the second trap in the closed position of the first and second traps based on said received size of the first cell and of the second cell, respectively, said gap being smaller than the respective cell so as to retain the cell in the trap.

In some embodiments, the size of the first and second cells can be entered manually by a user, for example through a user interface coupled to the control unit.

In other embodiments, the device can comprise a measuring unit coupled to the control unit and adapted to measure in real time the size of the first and second cells in the flow of the solution. The control unit thus receives in real time said measured size of the first and second cells and can adjust accordingly the operation of the actuators to adapt the gap between the fingers in the closed position.

In some embodiments, the device can comprise at least one mechanical or electrical sensor adapted to detect that a cell has been trapped in a trap.

For example, a mechanical sensor can in particular detect a mechanical force exerted by the cell onto at least one finger of the trap. Mechanical sensing can be achieved by measuring the resonance frequency of an actuator and by determining the number of trapped cells by the frequency shift of the actuator. Mechanical sensing can also be done with static measurement, in which one actuator can be displaced to compress the cells. The induced displacement on the second actuator by the cell rigidity is due to the presence of the cells. The number of cells can be thus evaluated by the displacement of the second actuator.

An electrical sensor can detect an electrical current flowing between the fingers of the trap through the cell. Electrical sensing can be achieved by measuring the electrical conductivity between the actuator pairs with and without trapped cells and by determining the number of trapped cells based on the reduction of the conductivity, which is due to the fact that the cells are less electrically conductive than the solution.

The device can be used in a system for analyzing real-time interactions of at least one pair or triplet of cells.

The system can comprise an optical sensor, an electrical sensor, a mechanical sensor and/or a chemical sensor configured to acquire data relating to the interaction of a pair or triplet of cells trapped by the device. Electrical and mechanical sensors can be used not only to check the presence of the cells as described above but also to determine the number of trapped cells and measure mechanical and/or electrical characteristic of the trapped cells. Optical and chemical sensors can detect fluorescence imaging the cell pairing and detect and quantify the cell interaction such as the activation of immunological response between these cells.

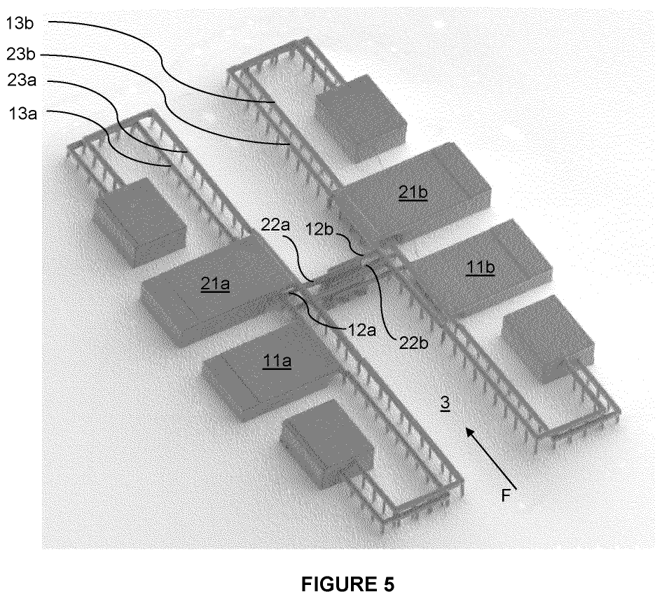

FIG. 5 illustrates a perspective view of a device according to an embodiment of the invention.

The device comprises a microfluidic channel 3, in which the direction of flow of a solution comprising cells is indicated by the arrow F.

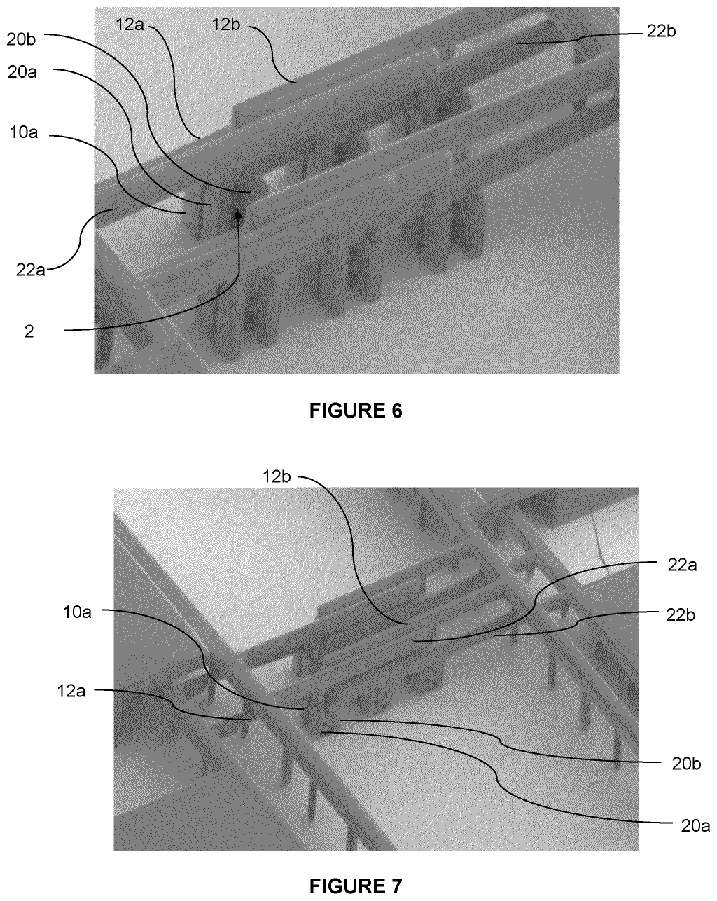

As better seen in FIGS. 6 and 7, the device comprises two rows of traps, each row comprising three first traps 1 and three second traps 2. FIG. 6 shows the traps in the open position, whereas FIG. 7 shows the traps in the closed position.

As explained above, each first trap 1 comprises a finger 10a and a finger 10b, and each second trap 2 comprises a finger 20a and a finger 20b.

The device comprises four actuators 11a, 11b, 21a, 21b arranged on either side of the traps. Each actuator can be a programmable stepper motor. For example, the actuator can be a piezoelectric linear motor.

The actuator 11a is configured to move the finger 10a of each first trap, the actuator 11b is configured to move the finger 10b of each first trap 1, the actuator 21a is configured to move the finger 20a of each second trap, and the actuator 21b is configured to move the finger 20b of each second trap.

To that end, each finger 10a, 10b, 20a and 20b is coupled to the respective actuator 20a, 20b, 21a, 21b by a respective rod 12a, 12b, 22a, 22b. The rods 12a, 12b, 22a, 22b extend substantially perpendicular to the flow F.

Thus, for each row of traps, the fingers 10a of the three first traps 1 are supported by the rod 12a and can be simultaneously moved by the actuator 11a, and the fingers 10b of said three first traps 1 are supported by the rod 12b and can be simultaneously moved by the actuator 11b; similarly, the fingers 20a of the three second traps 2 are supported by the rod 22a and can be simultaneously moved by the actuator 21a, and the fingers 20b of said three second traps 2 are supported by the rod 22a and can be simultaneously moved by the actuator 21b.

Advantageously, the device comprises two pairs of beams 13a, 13b, 23a, 23b extending along the flow F and connected to one of the rods 12a, 12b, 22a, 22b and to the respective actuator 11a, 11b, 21a, 21b. The rods extend in a direction substantially perpendicular to the beams.

Each end of said beams is fixed relative to the microfluidic channel but each beam is deformable in a direction transversal to the flow F by a respective actuator 11a, 11b, 21a or 21b to move the respective rod 12a, 12b, 22a or 22b in a direction transversal to the flow F to adjust the first or second traps.

In order to minimize assembly, each beam may be integrally formed with the corresponding rod and fingers. For example, the beam, rod and fingers can be made from a photopolymerized resin. To that end, methods known in the microelectronics field can be used.

Of course, the invention is not limited to the illustrated embodiment and can be implemented with different implementations of the actuators and mechanical transmissions between the actuators and the fingers. In addition, the number of traps can be adjusted depending on the needs of the experiment.

In some embodiments, release of a selected single trapped cell or trapped cell assembly (cell pair or cell triplet) may be achieved thanks to the generation of a bubble in the solution surrounding the traps, by electrolysis of said solution. To that end, the device includes, in the bottom of the microfluidic channel, a plurality of electrically isolated electrodes arranged to form an array. The nodes of the array (i.e. the areas in which two electrodes overlap) are located under the traps. In this way, when a sufficient potential difference is applied between two overlapping electrodes (i.e. a potential difference greater than a potential difference triggering electrolysis of the solution), a bubble is generated on the bottom of the microfluidic channel and rises in the solution in a substantially vertical direction so as to push a cell or a cell assembly out of the trap. The released cell or cell assembly may then be driven along the microfluidic channel by the flow of solution.

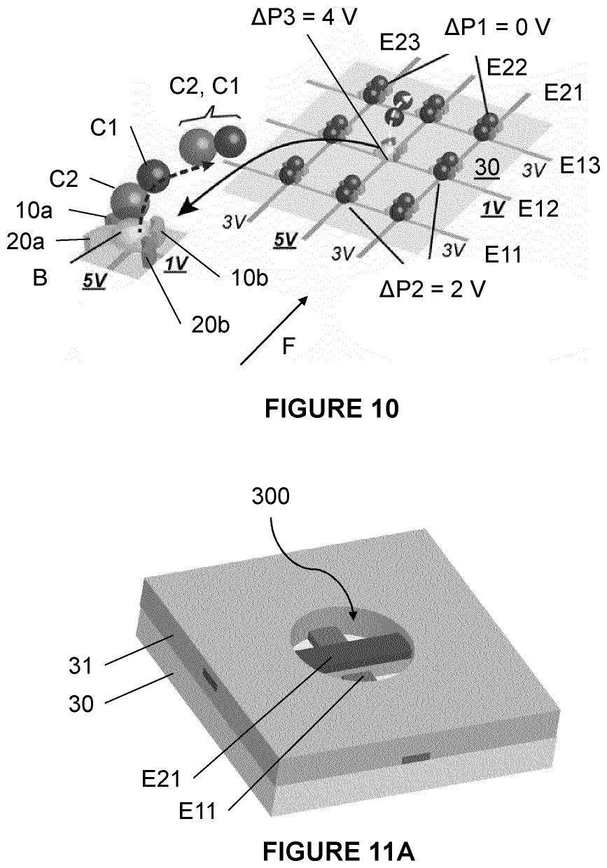

FIG. 10 schematically illustrates an array of electrodes arranged on the bottom 30 of the microfluidic channel. A first set of electrodes E11, E12, E13 extend perpendicular to the direction of flow F, whereas a second set of electrodes E21, E22, E23 extend parallel to the direction of flow F, and thus perpendicular to the first set of electrodes E11, E12, E13. Each electrode of the first set crosses an electrode of the second set under a respective trap. By “under” is meant here that the crossing or overlapping area is aligned with the trapping zone along a line perpendicular to the bottom of the microfluidic channel.

The first and second sets of electrodes are electrically isolated from each other.

Each electrode is connected to an electrical source configured to selectively apply a determined electrical potential to each electrode. As a result, a potential difference may be generated at each crossing area.

Depending on the electrical potential applied to each electrode, said potential difference may be greater than a potential threshold allowing electrolysis of the solution flowing in the microfluidic channel. In such case, a bubble is generated in the crossing area and rises in the solution to push a cell or a cell assembly from the respective trap. Thus, the cell or cell assembly can be retrieved from the trap without any activation of the actuators to move the fingers away from each other.

On the contrary, if the potential difference is less than the potential threshold, no electrolysis occurs and the cell assembly remains in the trap.

For example, in the embodiment illustrated in FIG. 10, an electrical potential of 3 V is applied to electrodes E11, E13, E21 and E23, an electrical potential of 1 V is applied to electrode E12 and an electrical potential of 5 V is applied to electrode E22. As a result, a potential difference ΔP1=0 V is applied at the crossing area between electrodes E13 and E21 and between electrodes E13 and E23; a potential difference ΔP2=2 V is applied at the crossing area between electrodes E12 and E21 and between electrodes E11 and E22; a potential difference ΔP3=4 V is applied at the crossing area between electrodes E12 and E22. Of course, the number of electrodes of each set and their relative arrangement is presented only for illustration and is not intended to be limitative.

Assuming that a potential difference of at least 3V is necessary to generate electrolysis of the solution, potential differences ΔP1 and ΔP2 are too low to generate electrolysis at the corresponding crossing areas; however, electrolysis is generated at the crossing area between electrodes E12 and E22 since ΔP3 is greater than 3 V. As a result, a bubble B is formed at the crossing area and rises in a substantially vertical direction to push the cell pair C1, C2 from the trap.

The applied potential difference depends on the electrode material, electrode geometry, and the solution (buffers or culture media) ionic strength and may be up to 20V DC. AC signals (up to 1 or 2 MHz) can also be applied for dielectrophoresis or AC electroosmosis to release a cell, cell pair or cell triplet.

The electrode array may be fabricated by patterning an electrically conductive material (such as indium tin oxide (ITO), or a metal such as gold) to form a first set of electrodes (e.g. a set of parallel electrodes) on the bottom of the microfluidic channel. The thickness of the electrodes can reach up to 500 nm. These electrodes are covered with a first dielectric layer, the thickness of the dielectric layer being greater than the thickness of the electrodes, so as to electrically isolate each electrode. The dielectric material may be for example SiO₂, spin-on-glass, or CYTOP™, which is a fluoropolymer.

A second set of electrodes is patterned perpendicular to the first set of electrodes and is then covered by a second dielectric layer having a thickness greater than the thickness of the electrodes so as to electrically isolate each electrode. The width of each electrode is of the same order as the size of the cells to be captured, for example a few micrometers.

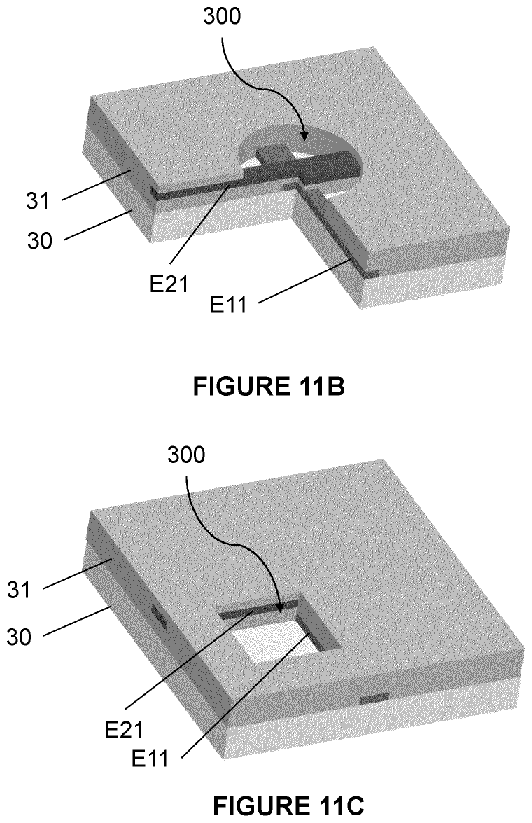

Then, the dielectric layers are etched around the overlapping electrode areas in order to form a recess in which at least a part of each electrode is exposed to the solution flowing in the microfluidic device. FIGS. 11A-11C schematically illustrate various embodiments of such a recess.

FIG. 11A illustrates a part of the bottom of the microfluidic device according to an embodiment, comprising a part of a first electrode E11 and of a second electrode E21 partially overlapping the first electrode. As mentioned above, the electrodes E11 and E21 are embedded in the first and second dielectric layers (here represented as a single dielectric layer 31). The recess 300 is formed through the dielectric layer 31 until the bottom 30 of the microfluidic channel. As best seen in FIG. 11B which is a partial sectional view of the recess of FIG. 11A, the etching partially exposes the upper and side surfaces of the second electrode E21 and the upper and side surfaces of the first electrode E11 on both sides of the overlapping second electrode E21. However, the etching does not remove the dielectric material located between the first and second electrodes.

The recess may have a circular shape, as represented in FIGS. 11A-11B, but it may have any suitable shape, for example rectangular or square (as shown in FIG. 11C). In the illustrated embodiment, the recess is centered on the overlapping area, but it could be placed differently, provided that at least part of the upper and/or side surfaces of each electrode is exposed.

FIG. 11C illustrates a part of the bottom of the microfluidic device according to another embodiment, comprising a part of a first electrode E11 and of a second electrode E21 partially overlapping the first electrode. As in FIG. 11A, the electrodes E11 and E21 are embedded in the first and second dielectric layers (here represented as a single dielectric layer 31). The recess 300 is formed through the dielectric layer 31 until the bottom 30 of the microfluidic channel. Contrary to the embodiment of FIG. 11A, the etching only exposes a side surface of the first and second electrodes E11, E21. In this embodiment, the recess is thus formed along one side surface of electrodes E11 and E21. As mentioned above, the etching does not remove the dielectric material located between the first and second electrodes.

The recesses allow the solution to be in contact with the electrodes only in the overlapping areas, or in the vicinity of the overlapping areas. Each recess is formed right below the traps allowing forming cell assemblies.

The size of the recess (e.g. the diameter for a circular recess, or the length/width for a square or rectangular recess) is chosen so as to generate a bubble of a size suitable for pushing the cell or cell assembly. To that end, the size of the recess (and of the resulting bubble) is equal to or slightly greater than the size of the cells, which may be of the order of 10 μm.

Moreover, the device of the invention can be used not only to study the interaction between immune cells, as mentioned above, but to study any cell-cell interaction, i.e., physical or chemical interaction between any kind of cells: cells of different size, cells of different sources, cell lines cells or primary cells, naturally occurring-cells or recombinantly produced cells. In particular, these cells can be circulating cells such as blood cells (such as erythrocytes, platelets, granulocytes, agranulocytes, etc.), urine cells, spermatozoa cells, fat cells (white or brown adipocytes), metastatic or circulating tumour cells, etc., or tissue-associated cells such as epithelial cells, fibroblast cells, ova cells, solid cancer cells, skin cells (keratinocytes, melanocytes, Merkel cells or Langerhans cells), muscle cells (skeletal, cardiac or smooth muscle cells), nerve cells (such as neurons or neuroglial cells), endothelial cells, pancreatic cells, cartilage cells, bone cells (such as osteoblasts, osteoclasts, osteocytes), etc. They can be differentiated cells or stem cells. They can be prokaryotic cells (e.g., bacteria) or eukaryotic cells (including yeast cells).

To be correctly trapped in the device of the invention, the cells to be studied have preferably a mean diameter higher than about 0.5 μm. In a particular embodiment, it is however possible to use the device of the invention to analyse the behaviour of these cells when contacted with smaller micro-organisms, such as bacteria, virus, protozoa, etc.

The device of the invention can tolerate some cell aggregation. However, in a particular embodiment, the concentration of the cells in the sample to be analysed should be adjusted so that there is no or few cell aggregation. For example, the concentration of cells in the solution that is flowed in the device of the invention is preferably below 500000 cells per millilitre. Higher concentrations can be diluted in the medium required for the survival of the type of the cells.

The cells from a blood sample are preferably isolated prior to insertion in the device.

As an example, the blasts used in the experiments below were isolated from peripheral blood after Ficoll separation and after lymphocyte depletion using immunomagnetic negative selection (CD3 for T-, and CD20 for B-lymphocytes).

In particular, the solutions (such as media and other solutions, e.g., plasma) to be used as flow in the channel can be filtered so that they do not contain cells or other components whose diameter is larger than 2 μm (when the studied cells have a diameter larger than 5 μm) or larger than one third of the diameter of the studied cells (when said cells are smaller than 5 μm in diameter).

Once the target cells are trapped within the device of the invention, a number of imaging techniques can be used to analyze the behavior of the cells. Imaging is the most powerful tool for visualizing the structure of the cells and their in live behavior. Many microscopy-based imaging approaches have been developed so far, such as confocal microscopy, super-high-resolution microscopy, two photon microscopy, electron microscopy and atomic force microscopy. Imaging can quantify proteins, RNAs, lipids and sugar chains using labeled antibodies.

The analysis of the real-time interactions of the trapped pair or triplet of cells may involve exposing the cells to a solution having a specific property, such as pH or viscosity, to simulate cell interactions in specific conditions. One or more solutions with different properties may thus be flown in the microfluidic channel in order to selectively access to a specific cell or to collectively access to the whole trapped cell pair or triplet.

In some embodiments, a selected cell or the whole trapped cell pair or triplet can be exposed to a solution with variable pH, in particular an acidic pH (for example about 6.2 to 6.5), which is less than the pH found in normal tissues (about 7.4). This allows accounting for the variability existing in vivo or in non-healthy conditions (acidic microenvironment in cancer tissue or in bone marrow).

In other embodiments, a selected cell or the whole trapped cell pair or triplet can be exposed to solutions having various viscosities, for example to mimic cell interaction in blood (the solution thus having a viscosity from 3 to 5 cP (3-5 mPa·s) which corresponds to average blood viscosity) and/or in bone marrow (the solution thus having a viscosity from 30 to 38 mPa·s which corresponds to average bone marrow viscosity).

Once the target cells are released from the device of the invention, other molecular tools can be used to decipher the molecular signaling pathways that have been altered by the cell-cell interaction. For example, flow cytometry can analyze individual cells quantitatively and in high throughput. Multiplex labeling identifies composition of various cell types based on surface protein marker expression. In addition, quantification of multiple proteins in single cells using dyes or fluorescently-labeled antibodies can be achieved using flow cytometry. Similarly, flow cytometry has also been used to measure mRNA or microRNA expression levels using labeled antisense nucleotides. In combination with Fluorescence Activated Cell Sorting (FACS), target cells can be isolated and collected in a high-throughput manner, enabling further comprehensive gene expression and proteomic analysis. Imaging flow cytometry is another high throughput approach to analyze thousands of individual cells per second by taking images of cells simultaneously to provide morphological information. Recent droplet-based technological advances have enabled transcriptomic profiling of single cells. Combined with DNA barcoding, thousands of individual cells can be now analyzed. Proteomic analysis in single cell is in need because transcription and actual protein amount is often different. While comprehensive analyses of proteins are not yet possible, mass cytometry is one of the most high-throughput protein analyses. Isolated cells are labeled with multiplexed metal-conjugated antibodies, and the amount of target proteins is detected by Cytometry by Time of Flight (CyTOF) mass spectrometry. The current technology enables to measure approximately 40 proteins simultaneously. Imaging-based mass spectrometry (IMS) is an approach that integrates the strength of imaging and unbiased proteomic analysis through matrix-assisted laser desorption ionization. By measuring mass/charge signals at various coordinates, it can analyze both the existence of target molecules and information about their localization in tissues. IMS enables analysis of thousands of proteins, lipids, and metabolites without labeling directly from the tissues. Other molecular tools are described in Nishida-Aoki N. and Gujral TS, Emerging approaches to study cell-cell interactions in tumor microenvironment, Oncotarget, 2019, 10(7): 785-797.

In a preferred embodiment, the device of the invention is used to study immunological synapses (IS), i.e., cell pairs involving immunological cells with their target cells. Functional analysis at the immunological synapse (IS) level is fundamental to improve the efficiency of immunotherapies currently used in clinic. Indeed, despite very promising results having been shown with immunotherapies targeting advanced cancers, a majority of patients do not respond to specific treatments. In this context, it is important to identify relevant biomarkers that could predict the efficiency of these therapeutic molecules.

Immunological synapses involve antigen-presenting cells (e.g., B cells, dendritic cells, macrophages, a cell that has been infected by a virus or a cancer cell) and target cells such as CD4⁺ T lymphocytes, CD8⁺ T lymphocytes, B lymphocytes, or Natural Killer cells (NK cells). In particular, the device of the invention can be used to study the specific interaction between dendritic cells and T cells, or between tumour cells and T cells.

In a particular yet preferred embodiment, the device of the invention is used to dissect out the contributions of cell-intrinsic (that is, T-cells parameters) and cell-extrinsic (that is, cancer cells parameters) factors during immune synapse responses, in a clinical context of cancer. The device of the invention indeed represents a highly valuable tool in the development of precision medicine, allowing for the study of immune synapses between T cells and cancer cells, restoration of T lymphocytes activity, or for understanding the molecular mechanisms underlying resistance to therapeutic molecules.

While T lymphocytes are generally associated with the elimination of tumour cells, inhibitory signalling pathways targeting immune effector cells and tumour cells can lead to tumour dormancy and/or tumour escape (B. Quesnel, Acta Pathologica, Microbiologica, et Immunologica Scandinavica, vol. 116, no. 7-8, pp. 685-94, 2008). In addition, tumour cells are proposed to display features (quiescence, dormancy, sternness . . . ) that could lead to resistance against T lymphocytes (B. Quesnel, Acta Pathologica, Microbiologica, et Immunologica Scandinavica, vol. 116, no. 7-8, pp. 685-94, 2008; Y. Touil et al., Scientific reports, vol. 6, p. 30405, 2016). Thus, understanding the dialogue between T cells and tumour cells is crucial to prevent relapses in patients.

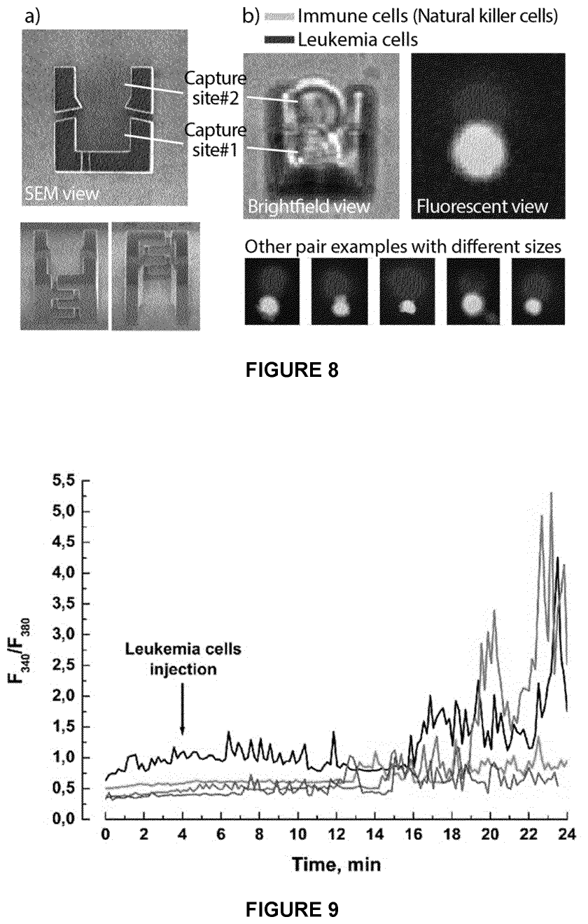

Thanks to the device of the invention, the dialogue between T cells and tumour cells can be observed, as explained above, by various conventional means (e.g., by transcriptomic, by proteomic, by genomics) and more precisely by checking Ca²⁺ signalling (cf. FIG. 8), the expression of checkpoint inhibitory proteins, or of sternness markers, for example by confocal microscopy, western blot and/or flow cytometry.

A preferred analysis tool is calcium signalling. It is well established that calcium signalling rules T cell activity (M. Trebak and J. P. Kinet, Nature reviews Immunology, vol. 19, no. 3, pp. 154-169, 2019). Moreover, calcium signalling has been associated with all the hallmarks of cancer (N. Prevarskaya, R. Skryma, and Y. Shuba, Physiological reviews, vol. 98, no. 2, pp. 559-621, 2018).

The device of the invention is well suited to perform functional studies on immunological synapses formed with primary cells of different sizes from patients and this despite the limited access to rare but crucial dysfunctional T cells or dormant tumour cells from patients.

Therefore, in a preferred embodiment, the device of the invention enables to decipher the calcium signature at the immunological synapse scale in a tumour dormancy context.

In a particular aspect, the invention proposes:
A system which gives the possibility to perform simultaneously functional analysis of the two types of cells (T cells and tumour cells from the same patient) during the immunological synapse formation and to follow the subsequent cellular events.
A system that allows to put in contact and to perform functional studies with rare cells having a low frequency, thereby enabling to analyse immunological synapse formation, even though it is a rare event in vivo. Indeed, very low number of cells are needed to perform the experiments with the device of the invention.
A system that allows to screen for therapeutic or candidate molecules able i) to reactivate T lymphocytes and to assess their efficiency against tumour cells at different stages of the disease, or ii) to make resistant cancer cells sensitive to T cells.

These investigations can be performed in a clinical context to assess the T lymphocytes activity (calcium responses, lysis) against tumour cells during the main stages of the disease (diagnosis, dormancy or minimal residual disease, relapse).

The Ca²⁺ signalling related to IS formation and the resulting cellular events can be evaluated via Ca²⁺ imaging and confocal microscopy. Ca²⁺ signalling can be investigated using specific inhibitors, agonists, antagonists, anti-inhibitory checkpoints (antibodies) and therapeutic or candidate molecules. Unravelling such regulatory mechanisms provides novel perspectives for immunotherapies or help optimizing current immunotherapies protocols.

Once the cells are released from the trap, the released cells can be further analyzed. It is then advantageous to collect specifically cells of the same category (e.g., only T cells, or only tumour cells) by sorting them with flow cytometry. Conventional molecular analysis can then be performed (immunostaining, western blotting, PCR, spectrometry, proteomics, etc.) to identify particular genomic or proteomic signatures or biomarkers in these cells.

The analysis of the T and resistant tumour cells released after having studied their immunological synapse may provide specific genomic signatures for each stage of cancer disease, or for each patient. In such a case, the device of the invention can enable the discovery of new biomarkers predicting the outcome of the disease.

### Example

A particular protocol using the device of the invention is as follows: prior to cell-loading, isolated NK cells and leukemia K562 cells have been cultured for 24 h to remove staining antibodies used for sorting according to their phenotype. Cancer cells have been stained with a viability/tracker dye (DiI). Single cell Ca²⁺ signaling in the IS has been monitored using SEM (cf. FIGS. 8 and 9). Ca²⁺ sensitive Fura-2 dye allows monitoring changes in cytoplasmic Ca²⁺ concentrations in real time. A “basal” Ca²⁺ signature (no stimulation) is compared to the one observed with NK cells.

This protocol allows to assess variations of intracellular Ca²⁺ levels during IS formation, but it can also be used to monitor
cytotoxic lysis,
resistance to lysis,
effects of IFN-g and TNF-α (cytokines) release in the IS on calcium responses,
etc.

Alternatively, T cells can be used instead of NK cells, and activated either using HLA-DR⁺ cancer cells preincubated with different concentrations of superantigens or pre-coating with anti-CD3 antibodies at different concentrations for IS. Cells can then be loaded with the ratiometric Fura-2 dye for Ca²⁺ signaling studies.

In particular, the expression and localization of key proteins involved in Ca²⁺ signaling, cytotoxic activity, apoptosis, proliferation and cytokines (IFN-g, TNF-α) release in the IS can be assessed. The molecular nature of the channels involved in the Ca²⁺ response elicited by the IS can be determined using selective inhibitors, that will be directly added to the microfluidic system. Modulation of calcium signaling in the IS with selective agonists, antagonists and therapeutic or candidate molecules will enable evaluating the potential restoration of T lymphocyte functions (proliferation, secretion of cytokines, cytotoxic lysis) and the proliferative/quiescent status of cancer cells.

1. A device for trapping at least one cell pair in a solution containing at least one first cell of a first type and at least one second cell of a second type, comprising:
a microfluidic channel designed for a unidirectional flow of the solution;
a first trap comprising a pair of first fingers arranged in the microfluidic channel, at least one of said first fingers being coupled to a respective first actuator, the respective first actuator being configured to adjust the first trap along a direction transversal to the flow between an open position allowing passage of the first cell between the first fingers and a closed position designed to a size of the first cell to allow trapping the first cell between the first fingers;
a second trap comprising a pair of second fingers arranged in the microfluidic channel, at least one of said second fingers being coupled to a respective second actuator, the respective second actuator being configured to adjust the second trap along a direction transversal to the flow between an open position allowing passage of the second cell between the second fingers and a closed position designed to a size of the second cell to allow trapping the second cell between the second fingers;
wherein the first trap is arranged relative to the second trap so as to form, when the first and second traps are in the closed position, a cell pair comprising the trapped first and second cells such that the second cell is in physical or chemical interaction with the first cell.

2. The device according to claim 1, wherein in the closed position the second trap is larger than the first trap so as to allow trapping a second cell larger than the first cell in the second trap.

3. The device according to claim 1, wherein each first finger is coupled to a respective first actuator and each second finger is coupled to a respective second actuator.

4. The device according to claim 3, wherein the first and second actuators are configured to move the first trap relative to the second trap to detach the first cell from the second cell and to open the first and second traps to release the first and second trapped cells within the flow.

5. The device according to claim 1, wherein each first or second finger is coupled to the respective first or second actuator by a respective first or second rod substantially perpendicular to the flow.

6. The device according to claim 5, wherein each of the first and second rods supports at least two first or second fingers, respectively, so as to form at least two first and second traps adjustable simultaneously by the first and second actuators, respectively.

7. The device according to claim 5, further comprising two pairs of foldable beams extending along the flow and connected to one of the first and second rods, each end of said foldable beams being fixed relative to the microfluidic channel, wherein each foldable beam is deformable by a respective first or second actuator to move the respective first or second rod in a direction transversal to the flow to adjust the first or second trap(s).

8. The device according to claim 1, further comprising a control unit configured to receive a size of the first and second cells and to control the first and second actuators to adjust a distance between the first fingers and between the second fingers in the closed position of the first and second traps based on said received size of the first cell and of the second cell, respectively.

9. The device according to claim 8, further comprising a measuring unit configured to measure in real time a size of the first and second cells, the control unit being configured to receive in real time said measured size of the first and second cells.

10. The device according to claim 1, further comprising at least one mechanical or electrical sensor configured to detect that a cell has been trapped in a respective first or second trap.

11. The device according to claim 1, wherein at least one of the first actuators is configured to adjust a size of the first trap in the closed position after a first cell has been trapped to allow trapping also one third cell in the first trap to form a cell triplet with the second cell trapped in the second trap, such that the first, second and third cells are in physical or chemical interaction.

12. The device according to any claim 1, further comprising a third trap comprising a pair of third fingers arranged in the microfluidic channel, at least one of said third fingers being coupled to a respective third actuator, the respective third actuator being configured to adjust the third trap along a direction transversal to the flow between an open position allowing passage of a third cell between the third fingers and a closed position designed to a size of the third cell to allow trapping the third cell between the third fingers;
wherein the third trap is arranged relative to the first and second traps so as to form, when the first, second and third traps are in the closed position, a cell triplet comprising the trapped first, second and third cells such that the first, second and third cells are in physical or chemical interaction.

13. The device according to claim 1, further comprising an array of electrically isolated electrodes arranged on a bottom of the microfluidic channel such that an overlapping area of two electrodes is located under each trap, at least one surface of each electrode being exposed in a recess in the overlapping area, each electrode being connected to an electrical source so as to selectively apply a potential difference to the solution at each overlapping area.

14. A method for trapping at least one cell pair in a solution containing at least one first cell of a first type and at least one second cell of a second type, comprising:
flowing the solution in the microfluidic channel of the device according to claim 1;
activating at least one first actuator to close the first trap, a size of the first trap in the closed position being designed to a size of the first cell;
trapping the first cell in the first trap;
activating at least one second actuator to close the second trap, a size of the second trap in the closed position being designed to a size of the second cell;
trapping the second cell in the second trap, the second cell forming a cell pair with the first cell, the second cell being in physical or chemical interaction with the first cell.

15. A method for trapping a cell triplet in a solution containing at least one first cell of a first type, at least one second cell of a second type different from the first type, and at least one third cell of a third type, comprising:
flowing the solution in the microfluidic channel of the device according to claim 1;
activating at least one first actuator to close the first trap, a size of the first trap in the closed position being designed to a size of the first cell;
trapping the first cell in the first trap;
activating at least one first actuator to adjust a size of the first trap in the closed position to be designed to a size of both the first and the third cells;
trapping the third cell in the first trap;
activating at least one second actuator to close the second trap, a size of the second trap in the closed position being designed to a size of the second cell;
trapping the second cell in the second trap, the second cell forming a triplet with the first and third cells, the first, second and third cells being in physical or chemical interaction.

16. The method according to claim 14 implemented with a device for trapping at least one cell pair in a solution containing at least one first cell of a first type and at least one second cell of a second type, comprising:
a microfluidic channel designed for a unidirectional flow of the solution;
a first trap comprising a pair of first fingers arranged in the microfluidic channel, at least one of said first fingers being coupled to a respective first actuator, the respective first actuator being configured to adjust the first trap along a direction transversal to the flow between an open position allowing passage of the first cell between the first fingers and a closed position designed to a size of the first cell to allow trapping the first cell between the first fingers;
a second trap comprising a pair of second fingers arranged in the microfluidic channel, at least one of said second fingers being coupled to a respective second actuator, the respective second actuator being configured to adjust the second trap along a direction transversal to the flow between an open position allowing passage of the second cell between the second fingers and a closed position designed to a size of the second cell to allow trapping the second cell between the second fingers;
wherein the first trap is arranged relative to the second trap so as to form, when the first and second traps are in the closed position, a cell pair comprising the trapped first and second cells such that the second cell is in physical or chemical interaction with the first cell,
wherein each first or second finger is coupled to the respective first or second actuator by a respective first or second rod substantially perpendicular to the flow,
wherein the first and second traps are in an initial open position in which the first trap is distant from the second trap in a direction transversal to the flow and wherein after the first and second cells have been trapped in the first and second traps, respectively, at least one of the first and the second actuator is activated to bring the first and second traps closer to each other to create the cell pair.

17. The method according to claim 16, further comprising releasing at least one of the first and second cells, by activating at least one of the first and second actuators, respectively, to move at least one of the first and second traps away from the other trap in a direction transversal to the flow and to open at least one of the first and second traps to release the first cell or the second cell trapped in the first trap or the second trap, respectively.

18. The method according to claim 14 implemented with a device for trapping at least one cell pair in a solution containing at least one first cell of a first type and at least one second cell of a second type, comprising:
a microfluidic channel designed for a unidirectional flow of the solution;
a first trap comprising a pair of first fingers arranged in the microfluidic channel, at least one of said first fingers being coupled to a respective first actuator, the respective first actuator being configured to adjust the first trap along a direction transversal to the flow between an open position allowing passage of the first cell between the first fingers and a closed position designed to a size of the first cell to allow trapping the first cell between the first fingers;
a second trap comprising a pair of second fingers arranged in the microfluidic channel, at least one of said second fingers being coupled to a respective second actuator, the respective second actuator being configured to adjust the second trap along a direction transversal to the flow between an open position allowing passage of the second cell between the second fingers and a closed position designed to a size of the second cell to allow trapping the second cell between the second fingers; and
an array of electrically isolated electrodes arranged on a bottom of the microfluidic channel such that an overlapping area of two electrodes is located under each trap, at least one surface of each electrode being exposed in a recess in the overlapping area, each electrode being connected to an electrical source so as to selectively apply a potential difference to the solution at each overlapping area;
wherein the first trap is arranged relative to the second trap so as to form, when the first and second traps are in the closed position, a cell pair comprising the trapped first and second cells such that the second cell is in physical or chemical interaction with the first cell, and
further comprising releasing at least one of the first and second cells from a selected trap by applying, to electrodes overlapping under the selected trap, an electrical potential difference greater than an electrical potential difference triggering electrolysis, dielectrophoresis or electroosmosis of the solution in a respective recess, so as to generate a bubble formed to push the at least one of the first and second cells out of the selected trap.

19. A method for analyzing real-time interactions of at least one pair of cells, comprising:
trapping at least one cell pair with a method according to claim 14;
acquiring data relating to the real-time interactions of the at least one cell pair with at least one of: an optical sensor, an electrical sensor, a mechanical sensor and a chemical sensor.

20. The method according to claim 19, further comprising exposing the at least one trapped cell pair to a solution having at least one of:
a determined pH chosen to simulate cell interactions in a determined situation; and
a determined viscosity chosen to simulate cell interactions in a determined situation.

21. A system for analyzing real-time interactions of at least one pair of cells, comprising:
a device according to claim 1, and
at least one of an optical sensor, an electrical sensor, a mechanical sensor and a chemical sensor configured to acquire data relating to interactions of a pair of cells trapped by the device.
